(19) United States
(12) Patent Application Publication
(10) Pub. No.: US 2016/0055742 A1
(43) Pub. Date: Feb. 25, 2016

(54) Switch Control System and Method Thereof

(71) Applicants: Ruizu (Ray) Wang, San Ramon, CA (US); Xiyun (Simon) Mao, San Jose, CA (US)

(72) Inventors: Ruizu (Ray) Wang, San Ramon, CA (US); Xiyun (Simon) Mao, San Jose, CA (US)

(21) Appl. No.: 14/829,677

(22) Filed: Aug. 19, 2015

Related U.S. Application Data
(60) Provisional application No. 62/038,836, filed on Aug. 19, 2014.

(51) Int. Cl. G08C 17/02; H04B 17/318

(52) U.S. Cl. CPC G08C 17/02; H04B 17/318

(57) ABSTRACT

Provided is an intelligent switch control system and method thereof. The system includes a transmitting radio frequency device, a receiving radio frequency device, and a control circuit for operating a switch. The control circuit is configured to use a predetermined pattern of the variation rate of measured RSSI between the two devices, as the basis to operate the switch. The switch can be used to open or close a door such as a garage door and a security door, trigger an action in a program, lock/unlock cars, turn on/off alarm systems, lights, televisions, stereos and DVD players, among others.

### CROSS-REFERENCE TO RELATED U.S. APPLICATIONS

This application is a non-provisional patent application claiming priority to U.S. Provisional Patent Application No. 62/038,836, filed Aug. 19, 2014, entitled “Intelligent Automatic Garage Door Close/Open System”, which is incorporated by reference to the extent not inconsistent with the present disclosure.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### FIELD OF THE INVENTION

The present invention relates generally to an intelligent switch control system and method thereof. Examples of the switches include those governing the opening or closing of a door such as a garage door and a security door. However, the present invention can also find applications in other areas such as software switch, locking and unlocking cars, and turning on/off alarm systems, lights, televisions, stereos and DVD players, among others.

### BACKGROUND OF THE INVENTION

Up to 50% of all residential burglaries are caused by an open garage door. Despite that people can push a button on a remote control to close the garage door, every day people are asking themselves the nagging question “did I forget to close my garage door?” This is simply because many times the driver cannot see, or visually confirm, the garage door is closed or is closing.

To solve the problem, a known solution is to send an alert to the driver warning the garage door has been left open. However, such solution relies on that the driver takes an extra action to close the door. First, taking extra action is not convenient for the driver while he/she is driving. Second, even when the action is taken, sometimes the driver may be already in a position where the door is not within his/her sight. Therefore, the uncertainty on whether the garage door is actually closed or not will make the driver feel mental uneasiness or nervousness, and the driver cannot enjoy a peace of mind afterwards.

In a number of wireless communication technologies, such as Cellular, WLAN, Bluetooth, ZigBee, etc., Received Signal Strength Indicator (RSSI) has been used to measure the distance and control the door switch. However, the solution is also far from satisfactory, since the door does not close in an intelligent way. For example, the door may not start to close while the door is still visible to a leaving driver.

Advantageously, the present invention can overcome the afore-mentioned problems, by providing an intelligent switch control system and method thereof.

### SUMMARY OF THE INVENTION

One aspect of the invention provides a switch control system. The system includes a transmitting radio frequency device, a receiving radio frequency device, a control circuit, and an actuator for operating a switch. The control circuit is configured to (i) generate a RSSI (t) function characterizing the variation of the RSSI value of the transmitting radio frequency device as measured by the receiving radio frequency device, with respect to time t, (ii) differentiate said RSSI (t) function to provide a first derivative function Fd1 (t) characterizing the variation rate of the RSSI value with respect to time t, (iii) generate a signal when said variation rate exhibits a predetermined pattern. The actuator actuates the switch in response to the signal to, for example, close or open a door.

Another aspect of the invention provides a method of operating a switch. The method comprises the following steps:

providing a transmitting radio frequency device and a receiving radio frequency device;

measuring the RSSI value of the transmitting radio frequency device with the receiving radio frequency device;

providing a RSSI (t) function characterizing the variation of the RSSI value with respect to time t;

differentiating said RSSI (t) function to provide a first derivative function Fd1 (t) characterizing the variation rate of the RSSI value with respect to time t;

generating a signal when said variation rate exhibits a predetermined pattern; and

actuating the switch in response to the signal.

In preferred embodiments, the method further comprises a step of authenticating the transmitting radio frequency device with the receiving radio frequency device to establish a trusted relationship therebetween.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

The present invention is illustrated by way of example, and not by way of limitation, in the figures of the accompanying drawings and in which like reference numerals refer to similar elements. For simplicity and clarity of illustration, elements shown in the Figures and discussed below have not necessarily been drawn to scale. Well-known structures and devices are shown in simplified form such as block diagrams in order to avoid unnecessarily obscuring the present invention.

FIG. 1 schematically illustrates an embodiment of the switch control system according to the present invention;

FIG. 2 is the schematic illustration of a scenario that a car is leaving a garage, wherein the system and method of the invention can find an application;

FIG. 3 schematically shows the curve of function RSSI (t) as measured in the scenario of FIG. 2;

FIG. 4 schematically shows the curve of function Fd1 (t) as measured in the scenario of FIG. 2;

FIG. 5 is the schematic illustration of a scenario that a car is coming back into a garage, wherein the system and method of the invention can find an application;

FIG. 6 schematically shows the curve of function Fd1 (t) as measured in the scenario of FIG. 5;

FIG. 7 is the schematic illustration of a scenario that a car is going through a security door, wherein the system and method of the invention can find an application;

FIG. 8 schematically shows the curve of function Fd1 (t) as measured in the scenario of FIG. 7;

FIG. 9 is the schematic illustration of a scenario that a car is passing by a door without an intention to entering the door, wherein the system and method of the invention can find an application;

FIG. 10 schematically shows the curve of function Fd1 (t) as measured in the scenario of FIG. 9; and

FIG. 11 shows an exemplary implementation of the switch control system according to the present invention.

### DETAILED DESCRIPTION OF THE PREFERRED EMBODIMENTS

In the following description, for the purposes of explanation, numerous specific details are set forth in order to provide a thorough understanding of the present invention. It is apparent, however, to one skilled in the art that the present invention may be practiced without these specific details or with an equivalent arrangement.

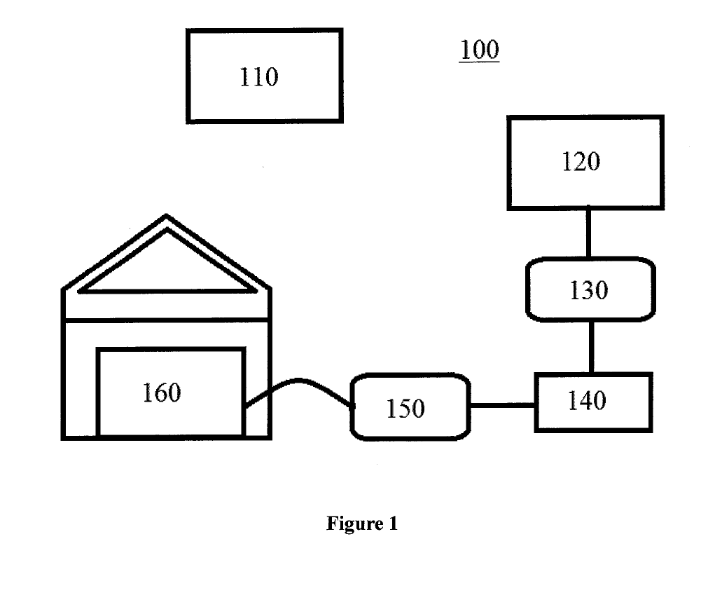

FIG. 1 schematically illustrates an embodiment of the switch control system according to the present invention. The system 100 includes a transmitting radio frequency device 110 that can be installed, for example, in a movable object such as a car. Installed in, e.g. a garage or a security gate is a receiving radio frequency device 120, which can be operatively connected to a control circuit 130. Circuit 130 controls an actuator 140 for operating a switch 150 that governs, for example, the opening or closing of a door 160 such as a garage door and a security door.

Examples of device 110/120 include, but are not limited to, dedicated devices, mobile telephones/cellphones, car and portable radios, RFID readers and transmitters, laptops or other devices including a transmitting and/or receiving processor. For example, they can be paired Bluetooth devices. A radio frequency network monitoring tool can also be used to measure the signal strength e.g. RSSI value of a wireless network.

Devices 110 and 120 are capable of transmitting/receiving electromagnetic waves in the radio frequency (RF) spectrum, within the range of from about 3 kHz up to 300 GHz. For example, devices 110 and 120 can operate in the 2.4 GHz radio bands. The term “radio frequency” or its abbreviation “RF” is used herein to describe wireless communication between devices 110 and 120, as opposed to communication via electric wires.

In some embodiments, both device 110 and device 120 support a radio frequency communication method selected from the group consisting of Global System for Mobiles (GSM); Code Division Multiple Access (CDMA); Bluetooth; ZigBee; and Wi-Fi.

Control circuit 130 may be built based on hardware circuitry (e.g. an IC chip), software instruction, or any combination thereof. In various embodiments, control circuit 130 is configured or programmed to generate a RSSI (t) function characterizing the variation of the RSSI value of the transmitting radio frequency device 110 as measured by the receiving radio frequency device 120, with respect to time t.

RSSI is a measure of the signal strength, not necessarily the quality, between transmitting and receiving devices 110 and 120 in a radio frequency environment. RSSI may be measured in arbitrary units. When transmitting messages between devices, RSSI value is a useful guide to the strength of the signal whether measured in Watts (W) or Decibels (dB). The value of RSSI measurements will vary depending on the implementation and the chosen scale, but is usually an integer value where a low value indicates a low signal strength. According to the IEEE802.11 standard: RSSI is intended to be used in a relative manner. Absolute accuracy of the RSSI reading is not specified.

RSSI value of the signal emitted from transmitting radio frequency device 110 and received by the receiving radio frequency device 120 is generally proportional to the inverse square of the distance (11d2). In practice, the distance or proximity between devices 110 and 120 can be estimated or calculated based on measured RSSI value.

When devices 110 and 120 are approaching to each other, or retreating (moving away) from each other, a RSSI (t) function characterizing the variation of the RSSI value of device 110 as measured by device 120, with respect to time t, can be generated, recorded and analyzed. For example, the transmitting radio frequency device 110 emits signals periodically, i.e. in a predetermined time interval, and on the other hand, the receiving radio frequency device 120 receives the signals, so to establish a raw data set with two coordinates (RSSI, t). A RSSI (t) function may then be created based on the data set using known mathematical methods. In practice, noises or fluctuations in RSSI measurement are sometimes prevalent. The fluctuations may be caused by, for example, changes in distance, interference from external material such as wood or metal between the radio frequency devices 110 and 120, and environmental conditions etc. In preferred embodiments of the invention, the raw data is further processed or treated to reduce the noise level. As a result, the curve/graph of RSSI (t) function may appear smoother or more continuous. In exemplary embodiments of the invention, methods such as simple moving average and exponential moving average may be employed toward that end.

In simple moving average method, a history of RSSI readings is averaged over to reduce the size of the fluctuations. In general, the fluctuations can be reduced further by increasing the number of periods that signal strength is averaged over. However, the lower the number of periods, the more sensitive the RSSI detection will be.

In order to reduce the time lag in simple moving averages, exponential moving averages (also called exponentially weighted moving averages or EMAs) can be used instead. EMAs reduce the lag by applying more weight to recent values relative to older values. The weighting applied to the most recent value depends on the specified period of the EMA. The shorter the EMA period, the more weight that will be applied to the most recent value. As such, EMAs will react quicker to recent changes than a simple moving average.

In various exemplary embodiments, control circuit 130 is configured to differentiate so-obtained RSSI (t) function to provide a first derivative function Fd1 (t) characterizing the variation rate (VR) of the RSSI value with respect to time t.

In single-variable calculus, differentiation and integration are the two fundamental operations. The process of finding a derivative is called differentiation, while the reverse process is called integration. The first derivative of function RSSI (t) is a measure of the rate at which the value of the function RSSI (t) changes with respect to the change of the variable t. If the graph of RSSI is plotted against time t, the derivative is the slope of this graph at each point. If RSSI (t) is a function that has a derivative at every point t for a period of time, then there is a function that sends the point t to the derivative of RSSI at t. This function is defined as the first derivative function Fd1 (t) according to the present invention.

The derivative Fd1 (t) of function RSSI (t) at a chosen input value t is the slope of the tangent line (instantaneous variation rate) to the graph of function RSSI (t) at that point. It therefore describes the best linear approximation of function RSSI (t) near that input value.

In various embodiments, control circuit 130 is configured to generate a signal when the variation rate (VR) exhibits a predetermined pattern, or exhibits a first predetermined pattern, if in the context or embodiments where two or more predetermined VR patterns are involved. Such interpretation of “first” and “second” applies to other applicable embodiments in the present invention.

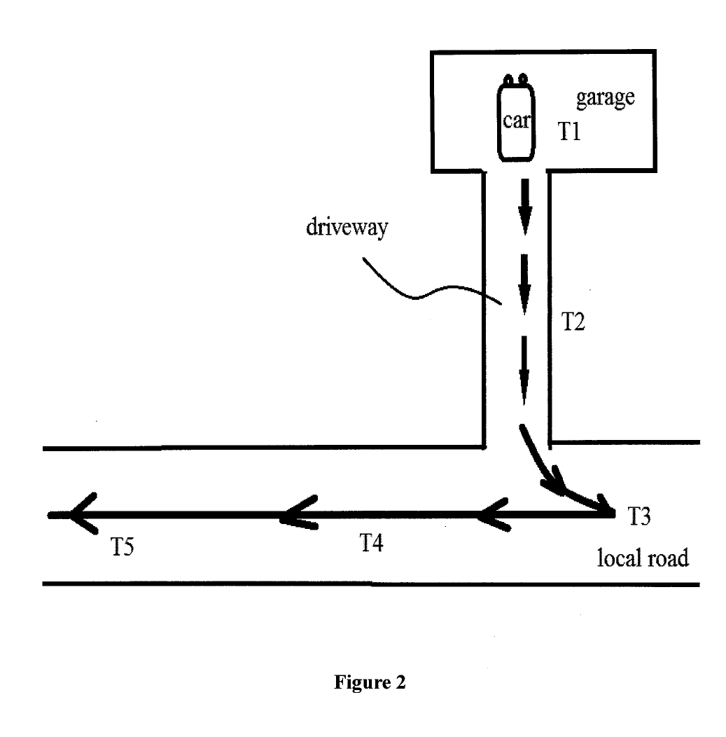

With reference to FIG. 2, a garage is equipped with a receiving radio frequency device 120 (not shown). The car parked in the garage is installed with a transmitting radio frequency device 110 (not shown). The car will move along the arrowed route as shown in FIG. 2. For simplicity, the car's location when t=Tx is abbreviated as location Tx in this writing. For example, location T2 and location T5 are intended to mean car's location when t=T2 and car's location when t=T5. In FIG. 2, the car moves backward from location T1 to T2 on the driveway, then to T3 on the local road. At location T3, the driver changes the car gear from reverse to forward, and then speeds up and drives away passing locations T4 and T5 on local road.

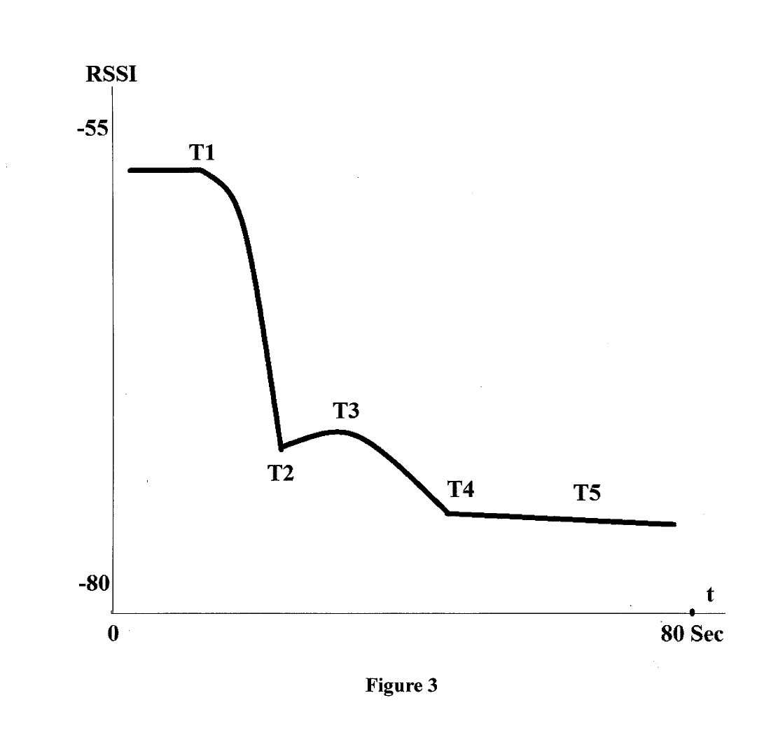

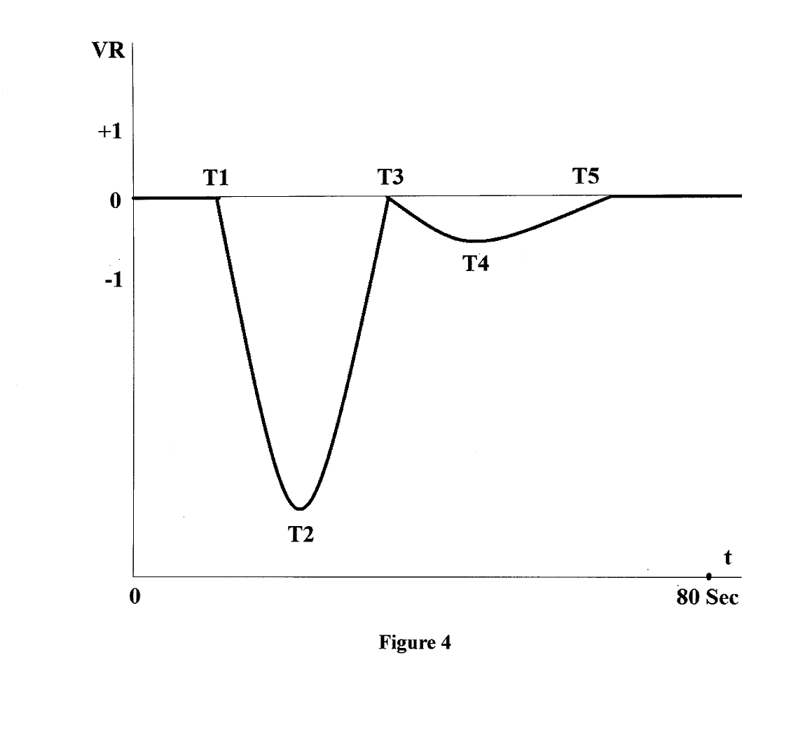

Referring to FIG. 2, when a leaving driver sits in the car and opens the garage door at t=T1, the generation of RSSI (t) function and Fd1 (t) function is initiated. The curve of RSSI (t) function, i.e., RSSI value change with respect to time variable t, is roughly illustrated in FIG. 3 (not to scale either). The curve of Fd1 (t) function, i.e., RSSI value variation rate (VR) with respect to time variable t, is roughly illustrated in FIG. 4 (not to scale).

Referring to FIG. 4, VR substantially monotonously decreases from a first zero value at t=T1, down to a first valley value at t=T2, and then substantially monotonously increases to a second zero value at t=T3. The pattern from T1 to T3 is an example of the so-called “a predetermined pattern” or “a first predetermined pattern”. Upon the appearance of such VR pattern, control circuit 130 (not shown in FIG. 3) as configured will generate a signal, in response to which actuator 140 (not shown in FIG. 3) will actuate switch 150 (not shown in FIG. 3) to close garage door 160 (not shown in FIG. 3).

In mathematics, a monotonic function (or monotone function) is a function between ordered sets that preserves the given order. For example, a monotonically increasing function is strictly increasing within an area of interest. In the present invention, the term “substantially monotonously decreases' from T1 to T2 is however loosely defined as that, as a trend, VR is decreasing between T1 and T2. For example, if Δt=T2−T1 is about 15 seconds, a 0.5-second noise-like small “jump” or “peak” on the curve from T1 to T2 does not change the overall trend that VR substantially monotonously decreases from a first zero value at t=T1, down to a first valley value at t=T2.

In another group of embodiments, control circuit 130 is configured to generate a signal when, not only the variation rate (VR) has exhibited the predetermined pattern or the first predetermined pattern, but the measured RSSI value has also satisfied a first predetermined threshold. Therefore, the signal is generated upon two condition ae met. Again using FIGS. 3 and 4 as representative examples, the first condition is the pattern between T1 and T3 as shown in FIG. 4, and as described above. The second condition is that the measured RSSI value has dropped below a first predetermined threshold. Referring back to FIG. 3, a RSSI value at a time in the neighborhood of T3 can be preset as the first predetermined threshold. Other suitable RSSI value, such as the one between T2 and T3, or between T3 and T4, may alternatively be set as the first predetermined threshold. In some embodiments of the invention, RSSI value threshold may be established based on the concept of Schmitt trigger known to a skilled artisan in the field.

To ensure that the door is absolutely closed, a second signal or a failproof signal may be generated and sent to the actuator to close the door or keep the already-closed door closed. The condition for the generation of the failproof signal may be a second predetermined Fd1 (t) pattern (or VR pattern), a second predetermined RSSI threshold, or any combination thereof. The conditions for generating the signal is summarized in Table 1 below for clarity.

TABLE 1

| # | Condition(s) to be met to generate the first signal |
|---|---|
| A1 | First predetermined VR pattern. |
| A2 | First predetermined VR pattern; and |
| | First predetermined RSSI threshold. |
| # | Conditions to be met to generate the second (failproof) signal |
| B1 | First predetermined VR pattern; and |
| | Second predetermined VR pattern. |
| B2 | First predetermined VR pattern; |
| | First predetermined RSSI threshold; and |
| | Second predetermined VR pattern. |
| B3 | First predetermined VR pattern; and |
| | Second predetermined RSSI threshold. |
| B4 | First predetermined VR pattern; |
| | First predetermined RSSI threshold; and |
| | Second predetermined RSSI threshold. |
| B5 | First predetermined VR pattern; |
| | First predetermined RSSI threshold; |
| | Second predetermined VR pattern; and |
| | Second predetermined RSSI threshold. |

Referring back to FIG. 3, a RSSI value at a time in the neighborhood of T4 or T5 can be preset as the second predetermined RSSI threshold. Other suitable RSSI value, such as the one between T4 and T5, or beyond T5, may alternatively be set as the second predetermined RSSI threshold. In various embodiments, the absolute value of the first predetermined RSSI threshold is significantly higher than that of the second predetermined RSSI threshold.

Referring back to FIG. 4, the second predetermined VR pattern may be defined as that the variation rate (VR) decreases from the second zero value (at T3) down to a second valley value (at T4), and then increases back toward zero line (at T5). In various embodiments, the absolute value of the first valley value may be at least 2-10 such as 3, 5, or 7 times higher than that of the second valley value.

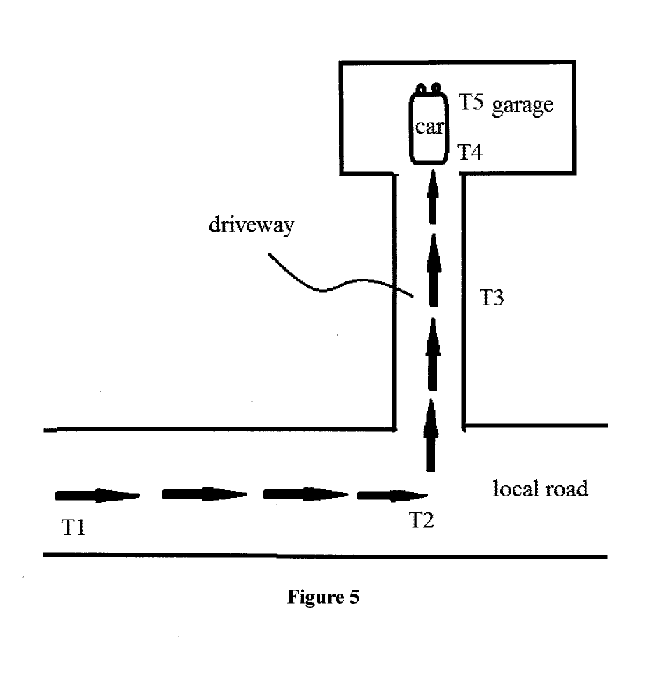

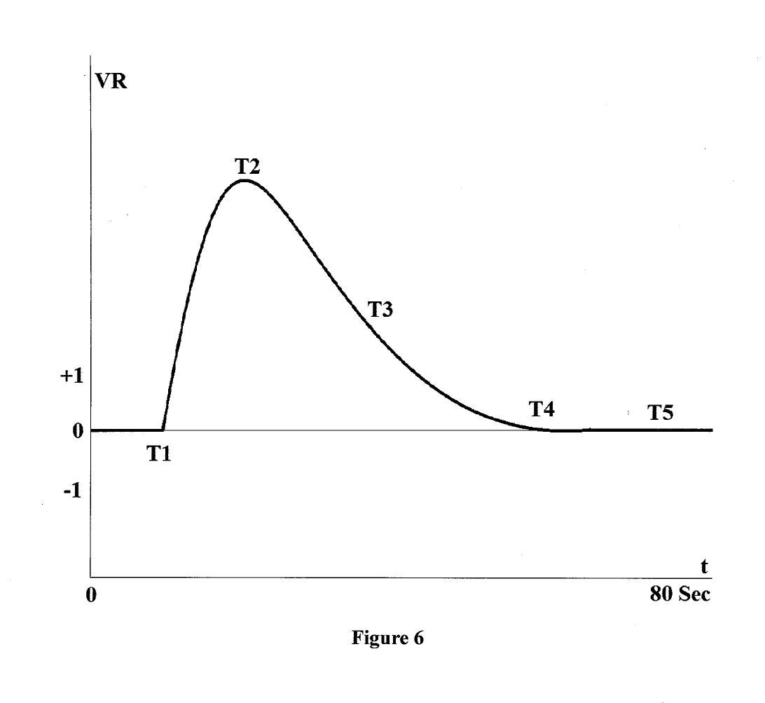

With reference to FIG. 5, a garage is equipped with a receiving radio frequency device 120 (not shown). A car installed with a transmitting radio frequency device 110 (not shown) comes back and enters the garage. The car will move along the arrowed route as labelled with car's location from T1 to T5, as shown in FIG. 5. It should be understood that the car turns left at T2, and stops at T4 and park there until T5. Therefore, location T4 is the same as location T5, but time T4 is not the same as T5. Under this setting, the curve of Fd1 (t) function, i.e., RSSI value variation rate (VR) with respect to time variable t, is roughly illustrated in FIG. 6 (not to scale). The first predetermined VR pattern (for opening door) in this example may be that VR increases from zero (at T1) to a peak value (at T2). Shortly (say 1 or 2 seconds) after T2, the garage door is triggered to open. Δt=T5−T4 (e.g. 5 seconds) can be a predetermined interval, upon which the door is triggered to close. In this case, the first predetermined VR pattern (for closing door) is VR remains 0 from T4 to T5. Translated into reality, the driver stops the car at T4. The control circuit will close the door after Δt, a predetermined interval, is passed, assuming the driver will not leave the garage in the near future.

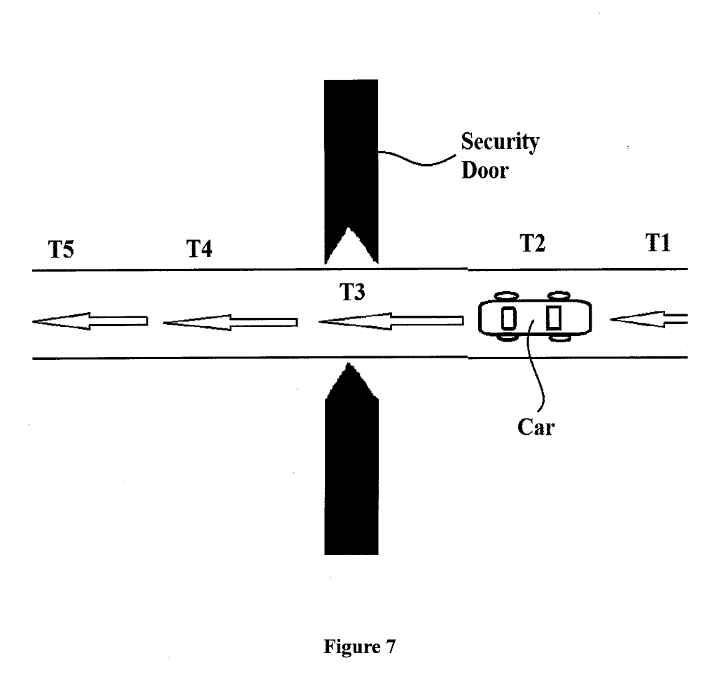

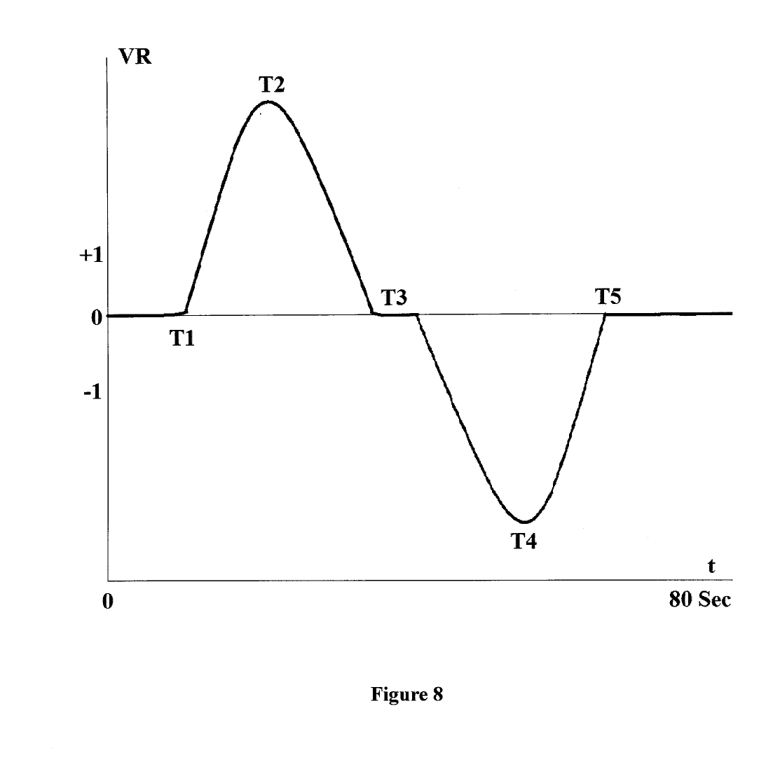

With reference to FIG. 7, a security door is equipped with a receiving radio frequency device 120 (not shown). A car installed with a transmitting radio frequency device 110 (not shown) moves along the arrowed route as shown in FIG. 7. The car comes from location T1 in the far right, moves toward the security door, and then passes through it at time T3. Under this setting, the curve of Fd1 (t) function, i.e., RSSI value variation rate (VR) with respect to time variable t, is roughly illustrated in FIG. 8 (not to scale). The first predetermined VR pattern (for opening door) in this example may be that VR increases from zero (at T1) to a peak value (at T2), and decreases back to zero (at T3). The security door is then triggered to open according to the control circuit 130 configuration. The first predetermined VR pattern (for closing door) in this example may be that VR decreases from zero (location T3, with a little bit lag after time T3) to a valley value (at T4), and increases back to zero (at T5). The security door is then triggered to close according to the control circuit 130 configuration. Translated into reality, the driver stops near the security door, and waits a little bit until the door is completely opened. Then the car resumes moving, passes through the door, and at T5, the security door behind the car is closed automatically.

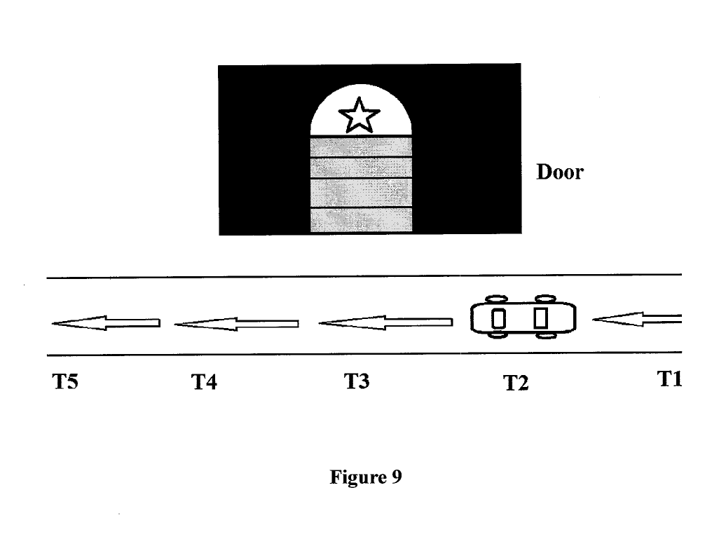

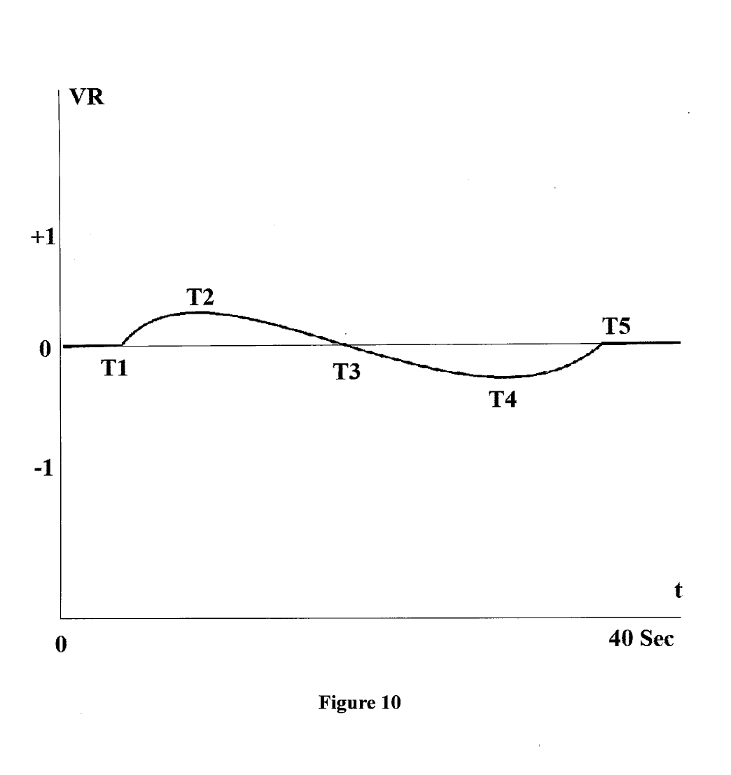

With reference to FIG. 9, a door (either a garage door or a security door) is equipped with a receiving radio frequency device 120 (not shown). A car installed with a transmitting radio frequency device 110 (not shown) moves along the arrowed route as shown in FIG. 9. The car comes from location T1 in the far right, passes by the door without any intention to enter the door, and then moves away from the door. Under this setting, the curve of Fd1 (t) function, i.e., RSSI value variation rate (VR) with respect to time variable t, is roughly illustrated in FIG. 10 (not to scale). The corresponding VR pattern is that VR increases from zero (at T1) to a peak value (at T2), decreases back to zero (at T3), further decreases to a valley value (T4), and then increases back to zero (T5). In contrast, the absolute value of the peak/valley value in this example is significantly lower than those in FIGS. 4, 6 and 8. Therefore, control circuit may be configured NOT to open the door when such a VR pattern featured with an absolute value of the peak/valley value lower than the minimal threshold. Control circuit 130 is preferably configured to use such a minimal threshold as an additional condition for opening a door, in embodiments associated with FIGS. 4, 6 and 8, and in any other applicable embodiments.

In various embodiments, the actuator 140 in FIG. 1 actuates the switch 150 in response to the signal to, for example, close or open a door 160. A switch directly or indirectly changes a device from one state to another. By way of example, a switch may change the state of a lock from locked to unlocked, or of an electronic device from on to off, or trigger an action in a program. The switch may be operable to perform, directly or indirectly, various operations, including without limitation, an electrical or software switch turning a device or product on or off, opening or closing a door, releasing a catch, locking or unlocking a door or window or the like. For example, the switch may be used to trigger another software application for application to other location-based services such as mapping a device location, asset tracking, routing, proximity based messaging, including guides, advertising, ticketing, security and safety.

Those skilled in the art will appreciate that the invention is useable in a wide range of applications. Without wishing to limit the possible uses of the invention, examples of where the core invention may be used include home automation systems, access control systems, gates, garages, vehicles, electronic consumer devices, security and alarm systems.

The configuration of control circuit 130 of the present invention can be customized to different application environments. The customization depends on many factors such as landscape, driveway length, driver's habit, RF wavelength, transmitter power, receiver quality, type, size, and height of antenna, mode of transmission, noise, and interfering signals.

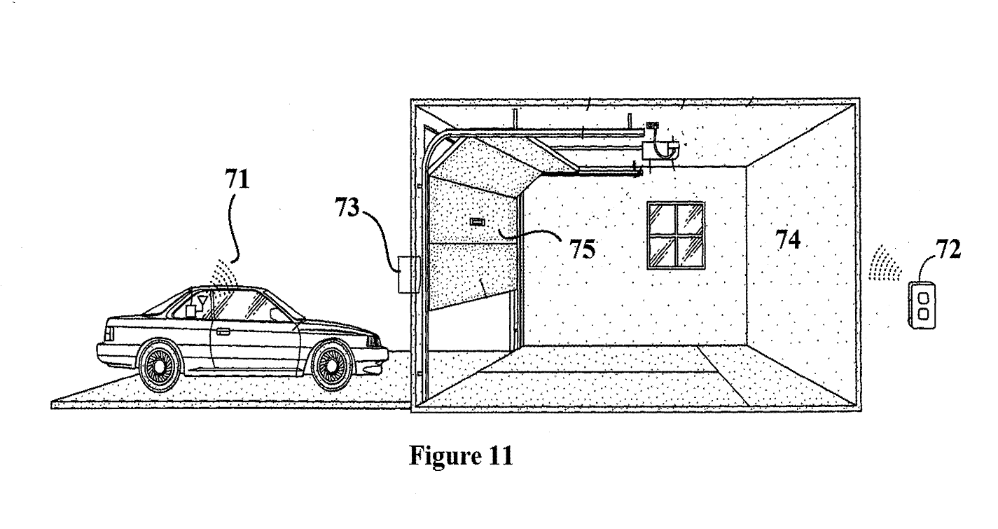

Components 120, 130, 140 and 150 in FIG. 1 can be combined or arranged in any convenient physical form, and can be operatively connected to each other in a wireless manner, wired manner, and any combination thereof. For example, control circuit 130 can be conveniently, and therefore preferably, installed in, or integrated into, receiving radio frequency device 120, although it can also be installed in, or integrated into, transmitting radio frequency device 110. System 100 can work with any traditional switch mechanisms in controlling a door such as a garage door. FIG. 11 shows an exemplary implementation of the switch control system according to the present invention.

With respect to FIG. 11, by adding three wireless devices to the existing garage door opener, car pulling out of garage 74 can be detected by searching for the following patterns: (1) The garage door is at the open position (by wireless device 73); (2) A continuous RSSI dropping trend is observed (by wireless device 72 recording RSSI from wireless device 71 shown in FIG. 11); (3) RSSI slope (VR) exceeds a predefined threshold; and (4) RSSI has dropped below a predefined level or died for a predefined period of time. Upon the detection of “car pulling out of garage”, the system will initiate the “closing garage door 75” action by device 72 sending the “push button” signal to the existing garage door opener.

Opposite to the above logic, this invention detects “car approaching to garage” by searching for the following patterns: (1) The garage door is at the closed position by device 73; (2) RSSI from device 71 is observed and increasing trend is recorded by device 72; and (3) RSSI slope exceeds a predefined threshold. Upon the detection of “car approaching to garage”, the system will initiate the “opening garage door” action by device 72 sending the “push button” signal to the existing garage door opener. The system of the invention can therefore intelligently detect that the car is pulling out of the garage, and automatically closes the garage door upon sensing the car is leaving home. If the owner just parks the car on the driveway, the garage door will be left as is. On the other hands, the system can also intelligently detect the approaching of the owner's car, and open the garage door upon sensing the car's arrival.

In some embodiments, control circuit 130 can be a specialized microcontroller designed specifically for controlling the switch. Alternatively, control circuit 130 can be a standard personal computer device such as an Intel processor-based PC running an off the shelf operating system such as Windows, Linux, MacOS, or the like. In some embodiments, control circuit 130 can include direct hardware interface such as a USB port, an RS232 interface, and IP network interface (wired or wireless), or some other type of connection, to load software to control the components and functions of the system. In some embodiments, control circuit 130 can interface with a touch-screen user interface that enables the user to set the parameters for automated control of the different components. In some embodiments, control circuit 130 can include software that allows the user to enter parameters for controlling the switch. In some other embodiments, the software allows the user to program the system and method of the invention.

Having thus described various illustrative embodiments of the present invention and some of its advantages and optional features, it will be apparent that such embodiments are presented by way of example only and are not by way of limitation. Those skilled in the art could readily devise alternations and improvements on these embodiments, as well as additional embodiments, without departing from the spirit and scope of the invention. All such modifications are within the scope of the invention as claimed.

1. A switch control system comprising:
a transmitting radio frequency device,
a receiving radio frequency device,
a control circuit, and
an actuator for operating a switch,
wherein the control circuit is configured to
(i) generate a RSSI (t) function characterizing the variation of the RSSI value of the transmitting radio frequency device as measured by the receiving radio frequency device, with respect to time t,
(ii) differentiate said RSSI (t) function to provide a first derivative function Fd1 (t) characterizing the variation rate of the RSSI value with respect to time t,
(iii) generate a signal when said variation rate has exhibited a first predetermined pattern, wherein said actuator actuates the switch in response to the signal.

2. The switch control system according to claim 1, wherein the control circuit is configured to generate said signal in (iii), when said measured RSSI value has also satisfied a first predetermined threshold.

3. The switch control system according to claim 1, wherein the control circuit is further configured to (iv) generate a failproof signal when said variation rate has exhibited a second predetermined pattern after the first one; and wherein said actuator actuates the switch again in response to the failproof signal.

4. The switch control system according to claim 1, wherein the control circuit is further configured to (iv) generate a failproof signal when said measured RSSI value has satisfied a predetermined threshold; and wherein said actuator actuates the switch again response to the failproof signal.

5. The switch control system according to claim 1, wherein the control circuit is realized based on hardware circuitry, software instruction, or any combination thereof.

6. The switch control system according to claim 1, wherein the switch governs the opening or closing of a door selected from the group consisting of a garage door and a security door.

7. The switch control system according to claim 1, wherein the switch governs an operation selected from the opening/closing of vehicle door, turning on/off alarm systems, turning on/off lights, turning on/off televisions, turning on/off stereos, and turning on/off DVD players.

8. A method of operating a switch, comprising:
(a) providing a transmitting radio frequency device and a receiving radio frequency device;
(b) measuring the RSSI value of the transmitting radio frequency device with the receiving radio frequency device;
(c) providing a RSSI (t) function characterizing the variation of the RSSI value with respect to time t;
(d) differentiating said RSSI (t) function to provide a first derivative function Fd1 (t) characterizing the variation rate of the RSSI value with respect to time t;
(e) generating a signal when said variation rate has exhibited a first predetermined pattern; and
(f) actuating the switch in response to the signal.

9. The method according to claim 8, further comprising a step of authenticating the transmitting radio frequency device with the receiving radio frequency device to establish a trusted relationship therebetween.

10. The method according to claim 8, wherein step (e) is generating a signal when said variation rate has exhibited a first predetermined pattern, and said measured RSSI value has also satisfied a first predetermined threshold.

11. The method according to claim 8, further comprising:
(g) generating a failproof signal when said variation rate has exhibited a second predetermined pattern; and
(j) actuating the switch again in response to the failproof signal.

12. The method according to claim 8, further comprising:
(g) generating a failproof signal when said measured RSSI value has satisfied a second predetermined threshold; and
(j) actuating the switch again in response to the failproof signal.

13. The method according to claim 8, wherein said differentiating said RSSI (t) function is conducted based on simple moving average or exponential moving average of measured RSSI values.

14. The method according to claim 8, wherein the switch governs the closing of a garage door, and wherein said first predetermined pattern in step (e) is that said variation rate substantially monotonously decreases from a first zero value down to a first valley value, and then substantially monotonously increases to a second zero value; and wherein said actuating the switch in response to the signal is to close the door.

15. The method according to claim 14, wherein step (e) is generating a signal when, in addition to that said variation rate has exhibited said first predetermined pattern, said measured RSSI value has dropped below a first predetermined threshold.

16. The method according to claim 14, further comprising:
(g) generating a failproof signal when said variation rate has exhibited a second predetermined pattern characterized in that said variation rate decreases from the second zero value down to a second valley value, and then increases back toward zero line; and
(j) actuating the switch again in response to the failproof signal to close the door or to keep the already-closed door closed.

17. The method according to claim 16, wherein the absolute value of the first valley value is at least 2-10 times higher than that of the second valley value.

18. The method according to claim 15, further comprising:
(g) generating a failproof signal when said variation rate has exhibited a second predetermined pattern characterized in that said variation rate decreases from the second zero value down to a second valley value, and then increases back toward zero line; and
(j) actuating the switch again in response to the failproof signal to close the door or to keep the already-closed door closed.

19. The method according to claim 14, further comprising:
(g) generating a failproof signal when said measured RSSI value has dropped below a second predetermined threshold; and
(j) actuating the switch again in response to the failproof signal to close the door or to keep the already-closed door closed.

20. The method according to claim 15, further comprising:
(g) generating a failproof signal when said measured RSSI value has dropped below a second predetermined threshold; and
(j) actuating the switch again in response to the failproof signal to close the door or to keep the already-closed door closed.
